(19) United States
(12) Patent Application Publication
(10) Pub. No.: US 2026/0172372 A1
(43) Pub. Date: Jun. 18, 2026

(54) DATA BROADCASTING METHOD FOR MESH OR TORUS NETWORK BASED ON XY ROUTING ALGORITHM, TRANSMISSION NETWORK AND ELECTRONIC DEVICE

(71) Applicant: Lemon Inc., Grand Cayman (KY)

(72) Inventors: Jun ZHENG, Los Angeles, CA (US); Chun LIU, Los Angeles, CA (US)

(21) Appl. No.: 18/984,000

(22) Filed: Dec. 17, 2024

(51) Int. Cl. H04L 49/15; H04L 49/25

(52) U.S. Cl. CPC H04L 49/1584; H04L 49/256

(57) ABSTRACT

A data broadcasting method for a mesh network or a torus network based on an XY routing algorithm, a transmission network, and an electronic device. The mesh or torus network includes a plurality of transmission nodes arranged in array along at least two directions including X and Y directions. The method includes: each of the transmission nodes, in response to receiving a broadcast data packet from a first neighboring transmission node in the X direction, transmitting the broadcast data packet to all neighboring transmission nodes except the first neighboring transmission node; and each of the transmission nodes, in response to receiving a broadcast data packet from a second neighboring transmission node in the Y direction, transmitting the broadcast data packet to neighboring transmission nodes, except the second neighboring transmission node, located in all other of the at least two directions except the X direction.

### TECHNICAL FIELD

Embodiments of the present disclosure relate to a data broadcasting method for a mesh network or a torus network based on an XY routing algorithm, a transmission network, and an electronic device.

### BACKGROUND

In scenarios such as network transmission or on-chip data transmission, the use of a transmission network is required to enable data transmission between different nodes or different modules. For example, a network-on-chip (NoC) connects multiple functional modules together through a series of routers and communication links, and these functional modules may be processing cores, caches, memory controllers, etc.

### SUMMARY

The part of summary is provided to describe concepts in a brief manner, and these concepts will be described in detail in the following part of detailed description. The part of summary neither is intended to identify key features or essential features of the claimed technical solutions, nor is intended to limit the scope of the claimed technical solutions.

At least one embodiment of the present disclosure provides a data broadcasting method for a mesh network or a torus network based on an XY routing algorithm, where the mesh network or the torus network includes a plurality of transmission nodes arranged in array along at least two directions, the at least two directions include X and Y directions that intersect each other, and in the XY routing algorithm, a data packet is routed along the X direction until the data packet reaches a Y axis where a destination transmission node of the data packet is located and the data packet is routed along the Y direction until the data packet reaches the destination transmission node, the method includes: each of the transmission nodes, in response to receiving a broadcast data packet from a first neighboring transmission node in the X direction, transmitting the broadcast data packet to all neighboring transmission nodes except the first neighboring transmission node; and each of the transmission nodes, in response to receiving a broadcast data packet from a second neighboring transmission node in the Y direction, transmitting the broadcast data packet to neighboring transmission nodes, except the second neighboring transmission node, located in all other of the at least two directions except the X direction.

At least one embodiment of the present disclosure provides a transmission network, where the transmission network is a mesh network or a torus network, the transmission network includes a plurality of transmission nodes arranged in array along at least two directions, the at least two directions include X and Y directions that intersect each other, and data broadcasting of the transmission network is implemented based on an XY routing algorithm, in the XY routing algorithm, a data packet is routed along the X direction until the data packet reaches a Y axis where a destination transmission node of the data packet is located and the data packet is routed along the Y direction until the data packet reaches the destination transmission node; where each of the transmission nodes is configured to, in response to receiving a broadcast data packet from a first neighboring transmission node in the X direction, transmit the broadcast data packet to all neighboring transmission nodes except the first neighboring transmission node; and in response to receiving a broadcast data packet from a second neighboring transmission node in the Y direction, transmit the broadcast data packet to neighboring transmission nodes, except the second neighboring transmission node, located in all other of the at least two directions except the X direction.

At least one embodiment of the present disclosure provides an electronic device, including a transmission network implementing data broadcasting based on an XY routing algorithm, where the transmission network is a mesh network or a torus network, the transmission network includes a plurality of transmission nodes arranged in array along at least two directions, the at least two directions include X and Y directions that intersect each other, and in the XY routing algorithm, a data packet is routed along the X direction until the data packet reaches a Y axis where a destination transmission node of the data packet is located and the data packet is routed along the Y direction until the data packet reaches the destination transmission node; where each of the transmission nodes is configured to, in response to receiving a broadcast data packet from a first neighboring transmission node in the X direction, transmit the broadcast data packet to all neighboring transmission nodes except the first neighboring transmission node; and in response to receiving a broadcast data packet from a second neighboring transmission node in the Y direction, transmit the broadcast data packet to neighboring transmission nodes, except the second neighboring transmission node, located in all other of the at least two directions except the X direction.

### BRIEF DESCRIPTION OF DRAWINGS

The above-described and other features, advantages and aspects of the respective embodiments of the present disclosure will become more apparent when taken in conjunction with the accompanying drawings and with reference to the detailed description below. Throughout the drawings, same reference signs refer to same elements. It should be understood that, the drawings are schematic and that originals and elements are not necessarily drawn to scale.

FIG. 1 is a schematic diagram of a two-dimensional network-on-chip;

FIG. 2 shows a schematic diagram of broadcasting from a center node to other nodes in the two-dimensional network-on-chip shown in FIG. 1;

FIG. 3 shows a schematic diagram of broadcasting from a corner node to other nodes in the two-dimensional network-on-chip shown in FIG. 1;

FIG. 4 shows a schematic diagram of a generalized two-dimensional mesh network divided from a node with coordinates (x, y);

FIG. 5 is a flowchart schematic of a data broadcasting method according to some embodiments of the present disclosure;

FIG. 6 is a schematic diagram of a transmission path of broadcast data packet in a two-dimensional network according to some embodiments of the present disclosure;

FIG. 7 shows a schematic diagram of broadcasting from a center node to other nodes in a two-dimensional network according to some embodiments of the present disclosure;

FIG. 8 is a flowchart schematic of another data broadcasting method according to some embodiments of the present disclosure;

FIG. 9 is a schematic diagram of a transmission path of broadcast data packet in a three-dimensional network according to some embodiments of the present disclosure;

FIG. 10 shows a schematic diagram of another two-dimensional network; and

FIG. 11 is a schematic diagram of retransmission according to some embodiments of the present disclosure;

FIG. 12 is a schematic diagram of an electronic device according to some embodiments of the present disclosure.

### DETAILED DESCRIPTION

Embodiments of the present disclosure will be described in more detail below with reference to the accompanying drawings. Although some embodiments of the present disclosure are shown in the drawings, it should be understood that the present disclosure may be embodied in various forms and should not be construed as limited to the embodiments set forth here, On the contrary, these embodiments are provided for a more thorough and complete understanding of the present disclosure. It should be understood that the drawings and the embodiments of the present disclosure are only for illustration purposes, and are not intended to limit the protection scope of the present disclosure.

It should be understood that the steps described in the method embodiments of the present disclosure may be performed in a different order and/or in parallel. In addition, the method embodiments may include additional steps and/or omit the steps shown. The scope of the present disclosure is not limited in this respect.

As used herein, the term “comprising” and its variations are open including, that is, “including but not limited to”. The term “based on” means “at least partially based on”. The term “one embodiment” means “at least one embodiment”; the term “another embodiment” means “at least one other embodiment”; and the term “some embodiments” means “at least some embodiments”. Relevant definitions of other terms will be given in the following description.

It should be noted that the concepts of “first” and “second” mentioned in the disclosure are only used to distinguish devices, modules or units, and are not used to limit that these devices, modules or units must be different devices, modules or units, nor to limit the order or interdependence of the functions performed by these devices, modules or units.

It should be noted that the modification “one” and “a plurality” mentioned in this disclosure are illustrative rather than restrictive, and those skilled in the art should understand that unless the context clearly indicates otherwise, they should be understood as “one or more”. “a plurality” should be understood to mean two or more.

The names of interactive messages or information between a plurality of devices in the embodiment of the present disclosure are for illustrative purposes only and should not restrict the scope of the messages or information.

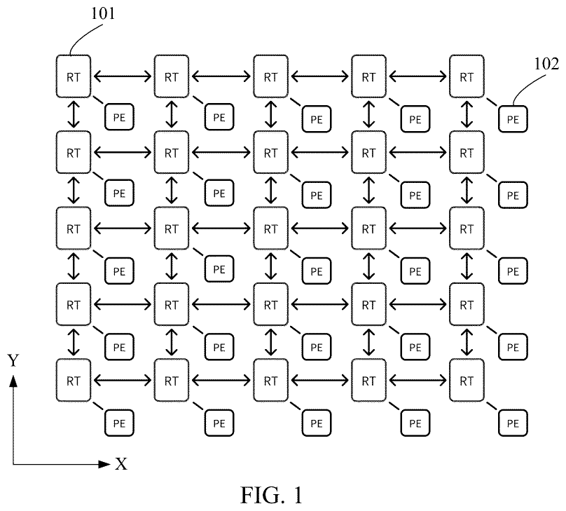

FIG. 1 is a schematic diagram of a two-dimensional mesh network.

As shown in FIG. 1, the two-dimensional mesh network includes a plurality of transmission nodes 101 arranged in array along an X direction (including an X positive direction and an X negative direction) and a Y direction (including a Y positive direction and a Y negative direction), and the transmission node may be a router. Each of the transmission nodes 101 may be connected to one processing unit 102, the transmission node 101 is used to implement routing in different directions, and the processing element 102 is used for injecting or offloading traffic and processing data. For example, the X direction may be a horizontal direction (a row direction), and correspondingly, the Y direction may be a vertical direction (a column direction). In other embodiments, the X direction may also be a vertical direction (the column direction), and correspondingly, the Y direction may be a horizontal direction (the row direction).

For example, in some of the following embodiments, the X direction is also referred to as an X-axis direction or a first direction, and the Y direction is also referred to as a Y-axis direction or a second direction.

In some examples, transmission of data in a two-dimensional network may be implemented with an XY routing algorithm. In the XY routing algorithm, a data packet is routed along the X direction until the data packet reaches an Y axis where a destination transmission node of the data packet is located, and then the data packet is routed along the Y direction until the data packet reaches the destination transmission node. For example, if it is required to transmit a data packet from a first transmission node to a second transmission node, the data packet may first be transmitted along the X direction until the data packet reaches a column where the second transmission node is located, and then transmitted to the second transmission node along the Y direction. With respect to this transmission mode, in a broadcasting scenario, if data is broadcast from the first transmission node to all other transmission nodes, it is required for the first transmission node to send one data packet to each of the transmission nodes except the first transmission node, causing total traffic of transmission to be too high, thus resulting in congestion.

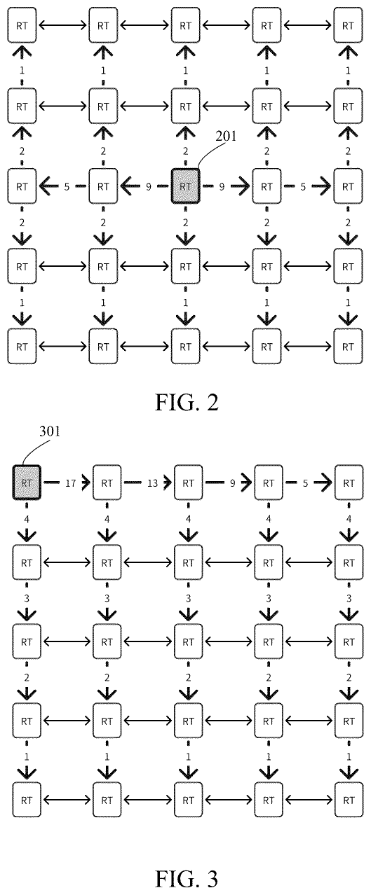

FIG. 2 shows a schematic diagram of broadcasting from a center node to other nodes in the two-dimensional mesh network shown in FIG. 1.

As shown in FIG. 2, assuming that the amount of data transmitted each time is 1 unit, in this exemplary 5×5 two-dimensional grid, the total traffic broadcast from the center node 201 to other nodes is 5+9+9+5+2*10+1*10=58. The one-way arrow represents an actual broadcasting path, and the number on the arrow represents a bandwidth unit.

FIG. 3 shows a schematic diagram of broadcasting from a corner node to other nodes in the two-dimensional mesh network shown in FIG. 1.

As shown in FIG. 3, assuming that the amount of data transmitted each time is 1 unit, in this exemplary 5×5 two-dimensional grid, the total traffic broadcast from the corner node 301 to other nodes is 17+13+9+5+ (4+3+2+1)*5=94. The one-way arrow represents an actual broadcasting path, and the number on the arrow represents a bandwidth unit. Therefore, with respect to the two-dimensional mesh network shown in FIG. 1, the total traffic of one broadcast communication is between 58 and 94.

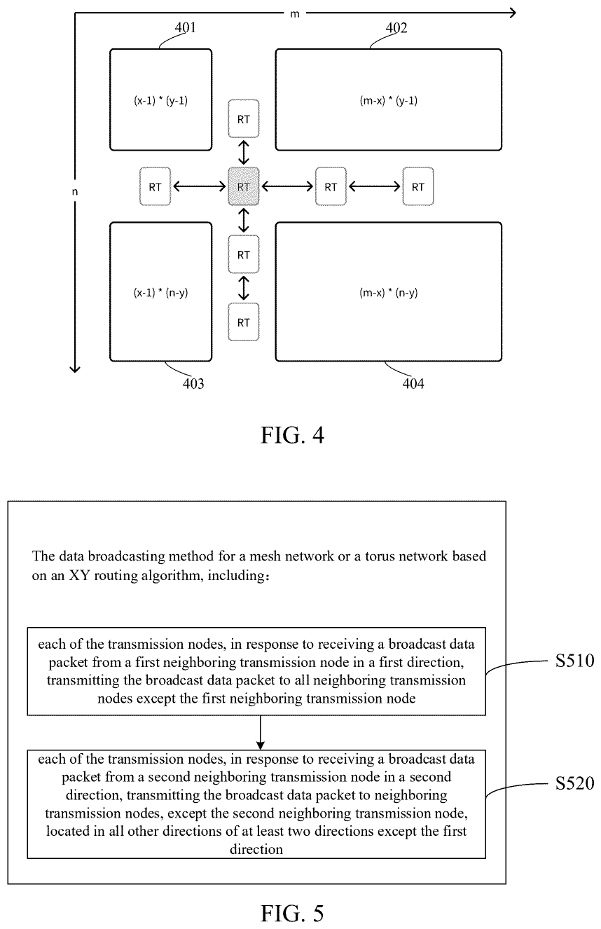

FIG. 4 shows a schematic diagram of a generalized two-dimensional mesh network divided from a node with coordinates (x, y).

As shown in FIG. 4, there are four regions demarcated by a row and a column where a node (x, y) is located, the number of nodes in the upper left corner region 401 is (x-1)*(y-1), the number of nodes in the upper right corner region 402 is (m-x)*(y-1), the number of nodes in the lower left corner region 403 is (x-1)*(n-y), and the number of nodes in the lower right corner region 404 is (m-x)*(n-y), where m is the total number of nodes in the horizontal direction and n is the total number of nodes in the vertical direction. The total traffic of communication from the node (x, y) to all other nodes is:

$$a 2 a ( m , n ) = a 2 a ( x - 1 , y - 1 ) + a 2 a ( m - x , y - 1 ) + a 2 a ( x - 1 , n - y ) + a 2 a ( m - x , n - y ) + ( m - 1 ) + ( n - 1 ) . \qquad ( 1 )$$

where a2a (m, n) represents the total traffic of communication from the node (x, y) to all other nodes, a2a (x-1,y-1) represents the traffic of communication from the node (x, y) to all nodes in the upper left corner region 401, a2a (m-x,y-1) represents the traffic of communication from the node (x, y) to all nodes in the upper right corner region 402, a2a (x-1,n-y) represents the traffic of communication from the node (x, y) to all nodes in the lower left corner region 403, and a2a (m-x, n-y) represents the traffic of communication from the node (x, y) to all nodes in the lower right corner region 404.

For example, the data traffic broadcast from the corner node is maximum, and the above equation (1) may be simplified to a following equation (2) to gain the maximum traffic broadcast in the two-dimensional mesh network:

$$a 2 a ( m , n ) = m * \sum ( n - 1 ) + ( n - 1 ) * \sum ( m - 1 ) + ( m - 1 ) \qquad ( 2 )$$

where Σ(n-1) represents a sum from 1 to n-1 and 2 (m-1) represents a sum from 1 to m-1.

Therefore, as can be seen from the above example, the use of the XY point-to-point routing algorithm for data broadcasting generates high traffic, easily causes congestion and has high bandwidth requirements.

For example, in yet other examples, an adaptive routing algorithm may be employed to route data packets to a non-congested path in accordance with congestion of each path. However, in large mesh networks, deadlocks are often caused when there are multiple sources that need to send data at the same time.

For example, in yet other examples, flooding algorithm may be used to enable broadcasting of data in a network-on-chip, e.g., the data is broadcast from the first transmission node to all transmission nodes except the first transmission node. In the broadcasting process, each of the transmission nodes, in response to receiving a broadcast data packet, sends the data packet to all other neighboring transmission nodes except a source node (a node from which the data packet is received), that is, each of the transmission nodes delivers the received broadcast data packet to all possible link paths until the broadcast data packet arrives destination. However, this algorithm might cause data packets to loop indefinitely within the network and lead to redundant traffic and low bandwidth efficiency, which in turn may lead to congestion and exhaust network resources.

Therefore, there is a need for a broadcasting algorithm that can improve bandwidth efficiency with no deadlocks and is simple and efficient.

At least one embodiment of the present disclosure provides a data broadcasting method for a mesh network or a torus network based on an XY routing algorithm, a transmission network, and an electronic device, allowing each of the transmission nodes in the transmission network to transmit a broadcast data packet from a first direction (an X direction) to all neighboring transmission nodes (except a source node), and to transmit a broadcast data packet from a second direction (a Y direction) to directions except the first direction (the X direction) but not to the first direction (except the source node), and in this way, broadcast data packets may not only be transmitted efficiently but also be transmitted to a remote side in an orderly manner, thus avoiding repeated passing through the same path or the same node. Therefore, this broadcasting method can improve bandwidth efficiency with no deadlocks and is simple and efficient.

The embodiments of the present disclosure will be illustrated in detail below with reference to the accompanying drawings.

At least one embodiment of the present disclosure provides a data broadcasting method for a mesh network or a torus network based on an XY routing algorithm. The mesh network or the torus network includes a plurality of transmission nodes arranged in array along at least two directions, the at least two directions including a first direction (X direction) and a second direction (Y direction) intersecting each other. The method includes: each of the transmission nodes, in response to receiving a broadcast data packet from a first neighboring transmission node in the first direction (the X direction), transmitting the broadcast data packet to all neighboring transmission nodes except the first neighboring transmission node; and each of the transmission nodes, in response to receiving a broadcast data packet from a second neighboring transmission node in the second direction (the Y direction), transmitting the broadcast data packet to neighboring transmission nodes, except the second neighboring transmission node, located in all other directions of the at least two directions except the first direction (the X direction).

For example, this data broadcasting method may be used for a process of data broadcasting in a transmission network, and the transmission network (a mesh network or a torus network) may be a network-on-chip of a chip or a network between network nodes. For example, the network-on-chip (NoC) may be used for communication between functional modules of a system-on-chip (SoC), and the system-on-chip may include modules such as multiple processor cores, caches, and memory controllers. A network node may be a computing node in a distributed computing system, and the network node may, for example, be a network device such as a computer or a server, and this data broadcasting method may be used for communication between multiple network devices. This data broadcasting method may be used in scenarios that require a large amount of data communication.

For example, the transmission network includes a plurality of transmission nodes arranged in array along at least two directions, the at least two directions including the first direction and the second direction intersecting each other. Any two of the at least two directions intersect each other, with each direction containing positive and negative directions. For example, with respect to a two-dimensional network, the at least two directions may include only the first and second directions, the first direction may be a horizontal direction, and the horizontal direction may be an X direction, including X positive and X negative directions. The second direction may be a vertical direction, and the vertical direction may be a Y direction, including Y positive and Y negative directions. With respect to a three-dimensional network, the at least two directions may further include a third direction in addition to the first and second directions, and third direction may be, for example, a perpendicular direction to an XY plane (a Z direction, including Z forward and Z negative directions). In addition, with respect to a higher-dimensional network, more directions may be included.

FIG. 5 is a flowchart schematic of a data broadcasting method according to some embodiments of the present disclosure.

As shown in FIG. 5, in at least one embodiment, the method includes the following steps S510-S520.

Step S510: Each of the transmission nodes, in response to receiving a broadcast data packet from a first neighboring transmission node in a first direction, transmitting the broadcast data packet to all neighboring transmission nodes except the first neighboring transmission node.

Step S520: Each of the transmission nodes, in response to receiving a broadcast data packet from a second neighboring transmission node in a second direction, transmitting the broadcast data packet to neighboring transmission nodes, except the second neighboring transmission node, located in all other directions of at least two directions except the first direction.

For example, data broadcasting for a mesh network or a torus network is carried out based on the XY routing algorithm, nodes except a broadcasting start node may be used as destination transmission nodes, then each Y axis (each column) may be used as a Y axis where the destination transmission node is located. In this way, a broadcast data packet may be routed in an X direction, and when the broadcast data packet reaches each Y axis, at least one broadcast data packet is copied and routed along the Y direction until the broadcast data packet reaches each destination transmission node.

For example, in step S510, the first neighboring transmission node in the first direction may refer to any neighboring transmission node located in the first direction of the current transmission node. If the first direction is the X direction, then the first neighboring transmission node in the first direction may be a neighboring transmission node in an X positive direction or an X negative direction of the current node. Each of the transmission nodes may determine a direction which a data packet is from in accordance with an interface that receives the data packet. After receiving a broadcast data packet from the first direction, each of the transmission nodes may send the data packet to all neighboring transmission nodes except the first neighboring transmission node, that is, in response to receiving the broadcast data packet from the first direction, each of the transmission nodes may transmit the broadcast data packet to all directions (except a source node). It should be noted that all directions described in some embodiments of the present disclosure refer to all layout direction of the transmission network.

For example, in step S520, the second neighboring transmission node in the second direction may refer to any neighboring transmission node located in the second direction of the current transmission node. If the second direction is the Y direction, then the second neighboring transmission node in the second direction may be a neighboring transmission node in a Y positive direction or a Y negative direction of the current node. After receiving a broadcast data packet from the second direction, each of the transmission nodes may transmit the data packet only to neighboring transmission nodes, except the source node, located in all other directions except the first direction, but not to a neighboring transmission node in the first direction. That is, in response to receiving a broadcast data packet from the second direction, each of the transmission nodes may transmit the broadcast data packet only to directions except the first direction (except the source node) but not to the first direction.

For example, what the above steps S510 and S520 describe are operations executed by the transmission node that receives the broadcast data packet. An initial transmission node of the broadcast data packet (a transmission node that originally issues the broadcast data packet, also called the source node) may send the broadcast packet to all neighboring transmission nodes when needing to send the broadcast data.

For example, in the two-dimensional network as shown in FIG. 1, there are some edge nodes that have only one neighboring transmission node in the first direction (the X direction), and in response to receiving a broadcast data packet from the unique neighboring transmission node in the first direction, such edge node may send the broadcast data packet to the neighboring transmission node in the second direction. Additionally, there are some edge nodes that have only one neighboring transmission node in the second direction, and in response to receiving a broadcast data packet from the unique neighboring transmission node in the second direction, such edge node may stop transmitting.

For example, in some embodiments, the transmission network may be a two-dimensional network, with a plurality of transmission nodes arranged along only two directions, a first direction and a second direction, the first direction being an X-axis direction and the second direction being a Y-axis direction. In step S510, each of the transmission nodes, in response to receiving a broadcast data packet from a first neighboring transmission node in the first direction, transmits the broadcast data packet to neighboring transmission nodes in the X-axis direction except the first neighboring transmission node, and to all neighboring transmission nodes in the Y-axis direction. In step S520, each of the transmission nodes, in response to receiving a broadcast data packet from a second neighboring transmission node in the second direction, transmits the broadcast data packet to all neighboring transmission nodes, except the second neighboring transmission node, located only in the second direction. For example, each of the transmission nodes, in response to receiving a broadcast data packet from the second neighboring transmission node in the Y-axis direction, transmits the broadcast data packet only to another neighboring transmission node in the Y-axis direction except the second neighboring transmission node, but not to a neighboring transmission node in the X-axis direction.

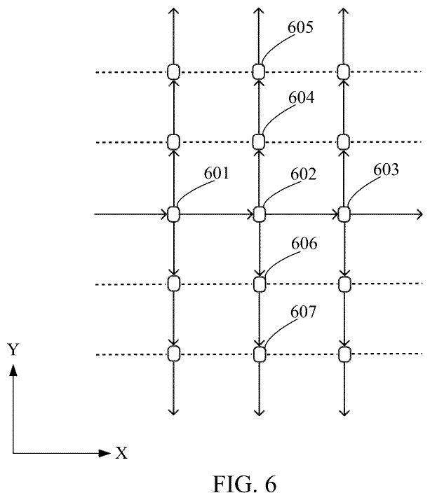

FIG. 6 is a schematic diagram of a transmission path of broadcast data packet in a two-dimensional network according to some embodiments of the present disclosure.

As shown in FIG. 6, a transmission node 602 receives a broadcast data packet sent from a neighboring transmission node 601 in the X-axis direction, and the transmission node 602 may send this broadcast data packet to another neighboring transmission node 603 in the X-axis direction and two neighboring transmission nodes 604 and 605 in the Y-axis direction. The transmission node 603 receives a broadcast data packet sent from the transmission node 602, and the transmission node 603 may send this broadcast data packet to another neighboring transmission node (not shown) in the X-axis direction and two neighboring transmission nodes in the Y-axis direction. For example, the transmission node 604 receives a broadcast data packet sent from the neighboring transmission node 602 in the Y-axis direction, and the transmission node 604 transmits this broadcast data packet only in the Y-axis direction (except the source node 602), that is, the broadcast data packet is sent only to another neighboring transmission node 605 in the Y-axis direction. Similarly, the transmission node 606 transmits only to another neighboring transmission node 607 in the Y-axis direction.

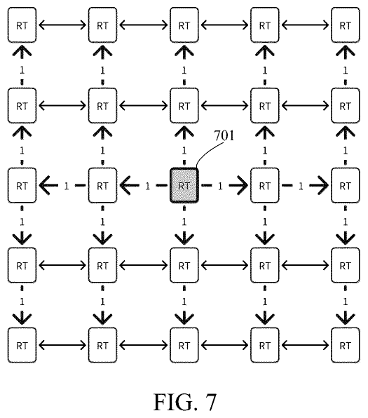

FIG. 7 shows a schematic diagram of broadcasting from a center node to other nodes in a two-dimensional network according to some embodiments of the present disclosure.

As shown in FIG. 7, in an exemplary 5×5 two-dimensional network, the total traffic broadcast from a center node 701 to other nodes is (5-1)+5*(5-1)=24, and for any other node, the traffic generated by broadcasting is the same as that of the center node, which is significantly lower than the traffic generated by the broadcasting in FIG. 2. A bandwidth cost of the broadcasting in the two-dimensional network shown in FIG. 7 is:

$$a 2 a ( m , n ) = m * n - 1 \qquad ( 3 )$$

where a2a (m, n) represents the total traffic of communication from a node (x, y) to all other nodes, m is the total number of nodes in the X-axis direction, and n is the total number of nodes in the Y-axis direction.

For example, in some embodiments, the at least two directions above may further include a third direction in addition to the first and second directions. For example, the first direction is the X-axis direction, the second direction is the Y-axis direction, the third direction is the Z axis direction, and the first, second, and third directions are perpendicular to each other in pairs.

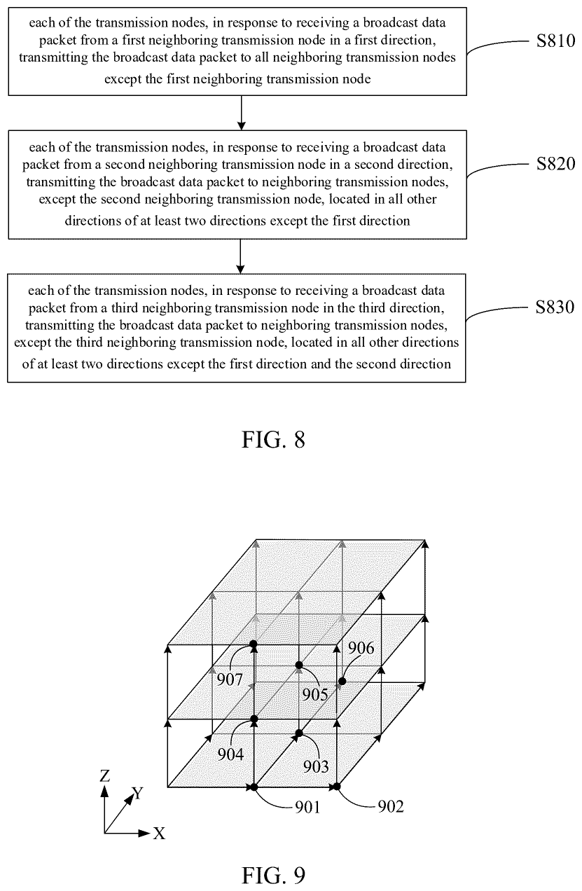

FIG. 8 is a flowchart schematic of another data broadcasting method according to some embodiments of the present disclosure.

As shown in FIG. 8, the data broadcasting method may include steps S810-S830.

Step S810: Each of the transmission nodes, in response to receiving a broadcast data packet from a first neighboring transmission node in a first direction, transmitting the broadcast data packet to all neighboring transmission nodes except the first neighboring transmission node.

Step S820: Each of the transmission nodes, in response to receiving a broadcast data packet from a second neighboring transmission node in a second direction, transmitting the broadcast data packet to neighboring transmission nodes, except the second neighboring transmission node, located in all other directions of at least two directions except the first direction.

Step S830: Each of the transmission nodes, in response to receiving a broadcast data packet from a third neighboring transmission node in the third direction, transmitting the broadcast data packet to neighboring transmission nodes, except the third neighboring transmission node, located in all other directions of at least two directions except the first direction and the second direction.

For example, for steps S810 and S820, reference may be made to the description above with respect to steps S510 and S520, and they will not be repeated here.

For example, in step S830, the third neighboring transmission node in the third direction may refer to any neighboring transmission node located in the third direction of the current transmission node. If the third direction is the Z axis direction, then the third neighboring transmission node in the third direction may be a neighboring transmission node in a Z axis positive direction or a Z axis negative direction of the current node. After receiving a broadcast data packet from the third direction, each of the transmission nodes may transmit the data packet only to neighboring transmission nodes, except the source node, located in all other directions except the first direction and the second direction, but not to neighboring transmission nodes in the first direction and the second direction. That is, in response to receiving a broadcast data packet from the third direction, each of the transmission nodes may transmit the broadcast data packet only to directions except the first direction and the second direction (except the source node), but not to the first direction and the second direction.

For example, the transmission network is a three-dimensional network, with a plurality of transmission nodes arranged along only three directions, the first direction, the second direction, and the third direction. Step S820 may include that each of the transmission nodes, in response to receiving a broadcast data packet from a second neighboring transmission node in the second direction, transmitting the broadcast data packet to all neighboring transmission nodes, except the second neighboring transmission node, located only in the second and third directions. Step S830 may include that each of the transmission nodes, in response to receiving a broadcast data packet from a third neighboring transmission node in the third direction, transmitting the broadcast data packet to all neighboring transmission nodes, except the third neighboring transmission node, located only in the third direction.

FIG. 9 is a schematic diagram of a transmission path of broadcast data packet in a three-dimensional network according to some embodiments of the present disclosure.

As shown in FIG. 9, a transmission node 901 receives a broadcast data packet sent from a neighboring transmission node in an X-axis direction, the broadcast data packet from the X-axis direction may be transmitted to X/Y/Z directions, and the transmission node 901 may thus send this broadcast data packet to another neighboring transmission node 902 in the X-axis direction, a neighboring transmission node 903 in the Y-axis direction, and a neighboring transmission node 904 in the Z axis direction. The transmission node 903 receives a broadcast data packet sent from the neighboring transmission node 901 in the Y-axis direction, the broadcast data packet from the Y-axis direction is transmitted only to the Y/Z directions, and thus the transmission node 903 sends this broadcast data packet only to another neighboring transmission node 906 in the Y-axis direction and a neighboring transmission node 905 in the Z axis direction. The transmission node 904 receives a broadcast data packet sent from the neighboring transmission node 901 in the Z axis direction, the broadcast data packet from the Z axis direction is transmitted only to the Z direction, and thus the transmission node 904 sends this broadcast data packet only to another neighboring transmission node 907 in the Z axis direction.

For example, a bandwidth of the transmission network along the second direction is greater than that along the first direction. For example, in an implementation of the present disclosure, when a plurality of nodes broadcast at the same time, a bandwidth pressure in the second direction is greater than that in the first direction, and therefore, the bandwidth in the second direction may be set to be greater than that in the first direction, e.g., the bandwidth in the second direction may be N times that in the first direction, and N is an integer greater than or equal to 2. The bandwidth in the second direction may be a bandwidth between any two neighboring transmission nodes in the second direction, and the bandwidth in the first direction may be a bandwidth between any two neighboring transmission nodes in the first direction. For example, with the transmission network including the third direction, a bandwidth of the transmission network along the third direction may be greater than that along the second direction.

With respect to the data broadcasting method according to the embodiments of the present disclosure, each of the transmission nodes transmits a broadcast data packet from the first direction to all neighboring transmission nodes (except the source node), transmits a broadcast data packet from the second direction to directions except the first direction (except the source node), and in this way, broadcast data packets may not only be transmitted efficiently, but also be transmitted to a remote side in an orderly manner, thus avoiding repeated passing through the same path or the same node. Therefore, this broadcasting method can improve bandwidth efficiency with no deadlocks and is simple and efficient.

For example, in some embodiments of the present disclosure, the first direction is the X-axis direction, the second direction is the Y-axis direction, and the third direction is the Z axis direction. It should be noted that these are only examples and are not used to limit the individual directions. In other embodiments of the present disclosure, with respect to a two-dimensional network, the first direction and the second direction may be set among the X/Y directions as needed, for example, the first direction may also be the Y-axis direction and the second direction may be the X-axis direction. With respect to a three-dimensional network, the first direction, the second direction, and the third direction may be set among the X/Y/Z directions as needed.

For example, a plurality of transmission nodes located in the same line in the transmission network are connected successively. In some embodiments, the plurality of transmission nodes located in the same line include two end nodes and at least one intermediate node located between the two end nodes, and the two end nodes are indirectly connected through the at least one intermediate node. That is, the two end nodes in the same line have no direct connection there between, but is connected only through the intermediate node. For example, the same line may refer to the same row, the same column, and so on.

For example, in the two-dimensional network shown in FIG. 7, a plurality of nodes in each row are connected successively, with the two end nodes in each row connected only to the intermediate node, and the same is true for the column direction. In this structure, when data broadcasting is carried out using the data broadcasting method of the embodiments of the present disclosure, a deadlock does not occur as a data packet does not pass through a repeating path.

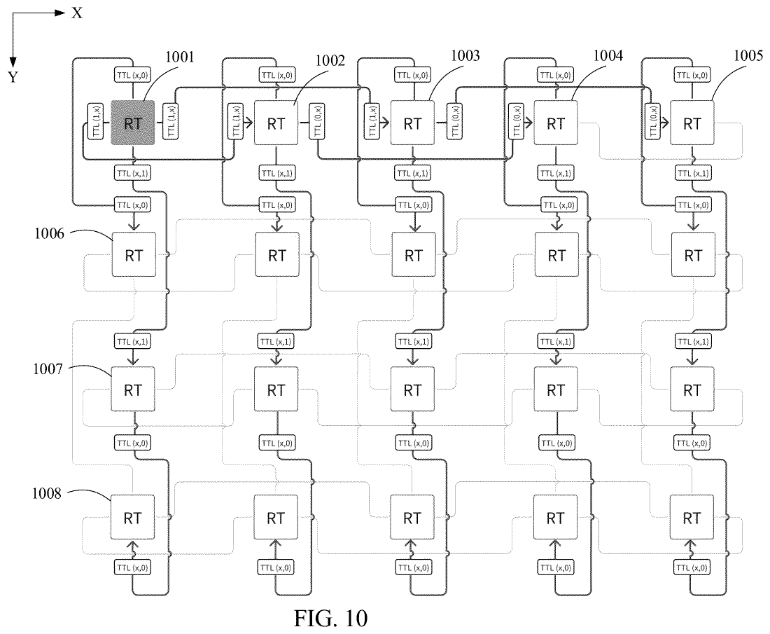

For example, in yet other embodiments, the plurality of transmission nodes located in the same line are connected end to end in succession one by one, forming a closed loop. In the same line, each node is connected to two nodes, and the end node described above may be considered as non-existent. For example, in the two-dimensional network shown in FIG. 7, directly connecting two end nodes in each row may allow the plurality of nodes in each row to be connected end to end in succession one by one to form a closed loop, and directly connecting two end nodes in each column may allow a plurality of nodes in each column to be connected end to end in succession one by one to form a closed loop. FIG. 10 shows a schematic diagram of a two-dimensional torus network. As shown in FIG. 10, a plurality of nodes in each row or column are also connected end to end in succession one by one, forming a closed loop.

For example, the term “neighboring” described in the embodiments of the present disclosure does not simply refer to neighboring in terms of physical location, but may be understood as neighboring in terms of physical connection, and two neighboring transmission nodes are two transmission nodes directly connected. In the two-dimensional mesh network as shown in FIG. 7, two transmission nodes that are neighboring in terms of physical location are also directly connected. In the two-dimensional torus network shown in FIG. 10, a first node 1001 and a third node 1003 in each row are not neighboring in terms of physical location, but they are directly connected and may thus be used as two transmission nodes that are neighboring.

For example, in a torus network with a plurality of transmission nodes located in the same line forming a closed loop, if the number of times a broadcast data packet is transmitted in each row is not limited, the broadcast data packet may be transmitted circularly in the same line. In order to avoid this problem, the following embodiments are provided.

For example, the plurality of transmission nodes include a first transmission node, the first transmission node being any one of the plurality of transmission nodes of the transmission network, and the data broadcasting method may further include: the first transmission node, in response to receiving a first broadcast data packet from a neighboring transmission node in a transmission direction, determining whether the number of times the first broadcast data packet is transmitted in the process of transmission along the transmission direction exceeds the limit, where the transmission direction is any of the at least two directions of the transmission network; and in response to determining that the number of times the first broadcast data packet is transmitted in the process of transmission along the transmission direction exceeds the limit, the first transmission node stops transmitting the first broadcast data packet to other neighboring nodes in the transmission direction.

For example, in an example with the transmission direction as the X-axis direction, in response to receiving the first broadcast data packet from the X direction, the first transmission node determines whether the transmission of the first broadcast data packet in the X-axis direction exceeds the limit to the number of transmitting, if yes, stops the transmission of the first broadcast data packet in the X-axis direction, and if not, continues to transmit the first broadcast data packet in the X-axis direction. In this way, it may be avoided that the first broadcast data packet is forwarded infinitely circularly in one direction.

For example, each of the at least two directions of the transmission network includes positive and negative directions. The initial transmission node of the first broadcast data packet is configured to send the first broadcast data packet in each of the at least two directions to two neighboring transmission nodes connected to either side of the second transmission node.

For example, with the two-dimensional torus network shown in FIG. 10 as an example, the X-axis direction includes X positive and X negative directions, and the Y-axis direction includes Y positive and Y negative directions. If the first broadcast data packet is broadcast to other nodes starting from a corner node 1001, the corner node 1001 is the initial transmission node of the first broadcast data packet, and the corner node 1001 may send the first broadcast data packet to all neighboring transmission nodes in the X-axis direction and the Y-axis direction. In the X-axis direction, the corner node 1001 is neighboring to two transmission nodes 1002 and 1003. The transmission node 1003 is connected to an interface in the X positive direction of the corner node 1001, so that the transmission node 1003 may act as a neighboring transmission node in the X positive direction of the corner node 1001; the transmission node 1002 is connected to an interface in the X negative direction of the corner node 1001, so that the transmission node 1002 may act as a neighboring transmission node in the X negative direction of the corner node 1001. In the X-axis direction, the corner node 1001 sends the first broadcast data packet to both the X positive and X negative directions. Similarly, in the Y-axis direction, the corner node 1001 sends the first broadcast data packet to both the Y positive and Y negative directions. For a higher-dimensional network (e.g., a three-dimensional network), the same is true in directions (e.g., the Z axis direction) except XY.

For example, the data broadcasting method may further include: the initial transmission node setting at least two sets of time-to-live values (TTL) corresponding to at least two directions, respectively, for the first broadcast data packet, where one set of time-to-live values corresponding to each direction includes a first time-to-live value and a second time-to-live value, the first time-to-live value is used to characterize the number of remaining number of transmissions of the first broadcast data packet in a positive direction of the corresponding direction, and the second time-to-live value is used to characterize the number of remaining number of transmissions of the first broadcast data packet in a negative direction of the corresponding direction; and each of the transmission nodes, which receives the first broadcast data packet, performing a subtracting operation on the time-to-live value of the first broadcast data packet in accordance with a direction in which the first broadcast data packet is received, to gain the updated survival value. The first transmission node determining whether the number of times the first broadcast data packet is transmitted in the process of transmission along the transmission direction exceeds the limit may include: if the time-to-live value when the first broadcast data packet is received is equal to a time-to-live threshold, then determining that the number of times the first broadcast data packet is transmitted in the process of transmission along the transmission direction exceeds the limit.

For example, in the X-axis direction, the first time-to-live value corresponding to the first broadcast data packet in the X positive direction and the second time-to-live value corresponding to the first broadcast data packet in the X negative direction sent from the corner node 1001 may be determined in accordance with the number of nodes arranged along the X-axis direction. For example, the corner node 1001 may set both an X-axis first time-to-live value and an X-axis second time-to-live value to 1, and the time-to-live threshold is 0. In the X positive direction, the X-axis first time-to-live value of the first broadcast data packet when received by the node 1003 is 1, which is greater than the time-to-live threshold of 0, so transmitting may be continued. The node 1003 first performs a subtracting operation on the X-axis first time-to-live value and then transmits it to a node 1005, for example, the node 1003 subtracts 1 on the basis of the X-axis first time-to-live value to update the X-axis first time-to-live value to 0, and then the node 1003 continues to transmit the first broadcast data packet to the node 1005. The X-axis first time-to-live value of the first broadcast data packet when received by the node 1005 is 0, which is equal to the time-to-live threshold, so that the node 1005 may stop transmitting of the first broadcast data packet in the X-axis direction. In the X negative direction, in response to receiving the first broadcast data packet, the node 1002 subtracts 1 from the X-axis second time-to-live value to update it to 0, and then transmits the first broadcast data packet to a node 1004. The X-axis second time-to-live value of the first broadcast data packet when received by the node 1004 is 0, and the transmitting of the first broadcast data packet in the X-axis direction is stopped.

For example, in the Y-axis direction, the corner node 1001 sets a Y-axis first time-to-live value to 1, and a Y-axis second time-to-live value to 0. In the Y-axis negative direction, the corner node 1001 transmits the first broadcast data packet to a node 1006, and the Y-axis second time-to-live value of the first broadcast data packet when received by the node 1006 is 0, so that the node 1006 stops transmitting of the first broadcast data packet in the Y-axis direction. In the Y-axis positive direction, the corner node 1001 transmits the first broadcast data packet to a node 1007, and the Y-axis first time-to-live value of the first broadcast data packet when received by the node 1007 is 1, so that transmitting in the Y-axis direction may be continued. The node 1007 first subtracts 1 from the Y-axis first time-to-live value to update the Y-axis first time-to-live value to 0, and then transmits the first broadcast data packet to a node 1008. The Y-axis first time-to-live value of the first broadcast data packet when received by the node 1008 is 0, so that the node 1008 stops transmitting of the first broadcast data packet in the Y-axis direction.

For example, when the number of nodes in a line where the initial transmission node is located is an odd number, the first time-to-live value and the second time-to-live value are both [N/2]-1. When the number of nodes in the line where the initial transmission node is located is an even number, the first time-to-live value is (N/2)-1, and the second time-to-live value is (N/2)−2, where N represents the number of nodes, and [.] is a round-down function.

For example, if the number of nodes arranged along the X-axis direction in each row is 5, the X-axis first time-to-live value and the X-axis second time-to-live value are both [5/2]-1=1. If the number of nodes arranged along the Y-axis direction in each column is 4, the Y-axis first time-to-live value is (4/2)-1=1 and the Y-axis second time-to-live value is (4/2)-2=0. Based on this manner, the first broadcast data packet may be allowed to traverse all the nodes in each line without causing repeated forwarding.

For example, the plurality of transmission nodes include a second transmission node, and the data broadcasting method further includes: the second transmission node, in response to an error occurring when receiving a second broadcast data packet, sending a retransmission request to an initial transmission node of the second broadcast data packet in a point-to-point manner; in response to receiving the retransmission request, the initial transmission node of the second broadcast data packet transmitting the second broadcast data packet to the second transmission node in a point-to-point manner.

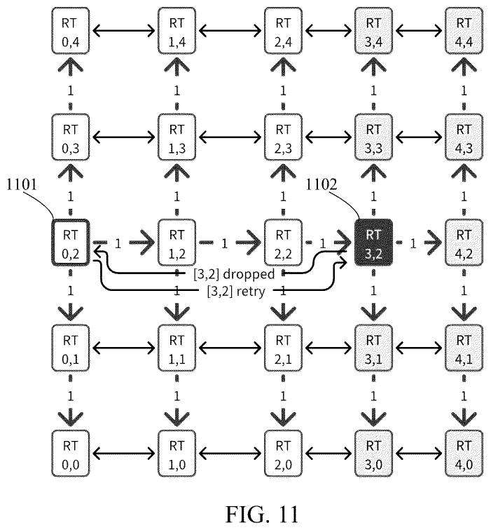

FIG. 11 is a schematic diagram of retransmission according to some embodiments of the present disclosure.

As shown in FIG. 11, the initial transmission node of the second broadcast data packet is a node 1101, the node 1101 transmits the second broadcast data packet to an X-axis direction and a Y-axis direction, and the second broadcast packet is lost or an error occurs when the second broadcast data packet is transmitted along an X axis to a node 1102. The node 1102 may send a point-to-point retransmission request to the node 1101, in response to receiving the retransmission request, the node 1101 sends the second broadcast data packet to the node 1102 in the point-to-point manner, and after receiving the second broadcast data packet, the node 1102 continues to broadcast the second broadcast data packet in the X-axis direction and the Y-axis direction.

An embodiment of the present disclosure further provides a transmission network. The transmission network is a mesh network or a torus network, the transmission network includes a plurality of transmission nodes arranged in array along at least two directions, where the at least two directions include X and Y directions that intersect each other, and data broadcasting of the transmission network is implemented based on an XY routing algorithm, in the XY routing algorithm, a data packet is routed along the X direction until the data packet reaches a Y axis where a destination transmission node of the data packet is located and the data packet is routed along the Y direction until the data packet reaches the destination transmission node. Each of the transmission nodes is configured to, in response to receiving a broadcast data packet from a first neighboring transmission node in the X direction, transmit the broadcast data packet to all neighboring transmission nodes except the first neighboring transmission node; and in response to receiving a broadcast data packet from a second neighboring transmission node in the Y direction, transmit the broadcast data packet to neighboring transmission nodes, except the second neighboring transmission node, located in all other directions of the at least two directions except the X direction.

For example, this transmission network may be a network-on-chip of a chip, or a network for data transmission between the plurality of network nodes. With regard to the transmission network, reference may be made to the relevant descriptions in the above embodiments with respect to the data broadcasting method, and repeating is omitted here.

An embodiment of the present disclosure further provides an electronic device, including a transmission network according to at least one embodiment of the present disclosure. In addition, the electronic device may further include multiple functional modules such as a processor, a memory, and input/output interfaces, and the functional modules is each connected to the transmission network and communicates over the transmission network. The electronic device may be a computer, a server, and other devices.

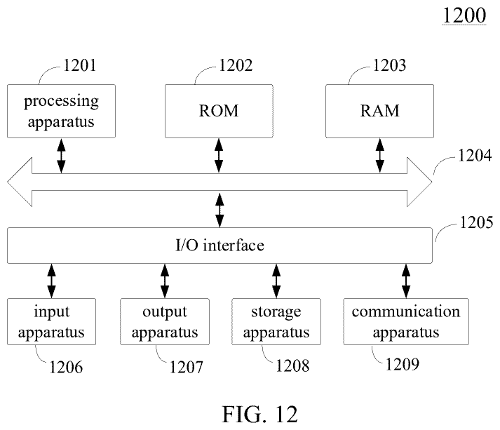

Referring to FIG. 12 below, it shows an exemplary schematic structural diagram applicable to implementing an electronic device 1200 (such as the terminal device or server in FIG. 1) according to embodiments of the present disclosure. The terminal device in the embodiment of the present disclosure may include, but not limited to, a mobile terminal such as a mobile phone, a notebook computer, a digital broadcast receiver, a PDA (personal digital assistant), a PAD (tablet computer), a PMP (portable multimedia player), and a vehicle terminal (such as a vehicle navigation terminal), as well as a fixed terminal such as a digital TV and a desktop computer. The electronic device shown in FIG. 12 is merely an example, and should not constitute any limitation on functions and use scope of embodiments of the present disclosure.

As shown in FIG. 12, the electronic device 1200 may include a processing apparatus 701 (such as central processing unit, etc.) that may perform various suitable actions and processing according to a program stored in a read-only memory (ROM) 1202 or loaded from a storage apparatus 1206 into a random access memory (RAM) 1203. The RAM 1203 further stores various programs and data necessary for an operation of the electronic device 1200. The processing apparatus 1201, the ROM 1202, and the RAM 1203 are connected to each other through a bus 1204. An input/output (I/O) interface 1205 is also connected to the bus 1204.

Usually, the following apparatuses may be connected to the I/O interface 1205: an input apparatus 1206 including, for example, a touchscreen, a touchpad, a keyboard, a mouse, a camera, a microphone, an accelerometer, a gyroscope, or the like; an output apparatus 1207 including, for example, a liquid crystal display (LCD), a speaker, a vibrator, or the like; a storage apparatus 1208 including, for example, a magnetic tape, a hard disk, or the like; and a communication apparatus 1209. The communication apparatus 1209 may allow the electronic device 1200 to communicate in a wireless or wired manner with another device to exchange data. Although FIG. 12 shows the electronic device 1200 with various apparatuses, it should be understood that it is not required to implement or own all the shown apparatuses. More or fewer apparatuses may alternatively be implemented or owned.

The bus 1204 may be implemented as a transmission network for any embodiment of the present disclosure, used to perform the functions defined in the method of the present disclosure.

The flowcharts and the block diagrams in the drawings show possible architectures, functions and operations of the system, the method and the computer program product according to the embodiments of the present disclosure. In this regard, each block in the flowchart or the block diagram may represent a module, a program segment, or a part of code. The module, the program segment, or the part of the code contains one or more executable instructions for implementing specified logic functions. It should be also noted that in some alternative implementations, the functions marked in the blocks may also occur in a different order from those marked in the drawings. For instance, two consecutive blocks may actually be executed basically in parallel, and sometimes, may also be executed in a reverse order, determined by involved functions. It should be also noted that each block in the block diagram and/or the flowchart and the combination of the blocks in the block diagram and/or the flowchart may be implemented by a dedicated hardware-based system that performs a specified function or operation, and may also be implemented by the combination of a special hardware and computer instructions.

Units involved in the embodiments of the present disclosure may be implemented by software, and may also be implemented by hardware. The name of the unit should not define the unit under certain circumstances.

The functions described above in this document may be at least partially executed by one or more hardware logical units. For instance, without limitation, demonstration type hardware logical units that may be used include: field programmable gate array (FPGA), application-specific integrated circuit (ASIC), application specific standard parts (ASSP), system on a chip (SOC), complex programmable logic device (CPLD), etc.

An embodiment of the present disclosure further provides a distributed system, and the distributed system includes a plurality of network nodes and a transmission network according to at least one embodiment of the present disclosure. The network nodes may be data processing nodes such as computers, servers, and databases. The transmission network may be a single network or a combination of at least two different networks. For example, the transmission network may include, but is not limited to, one or a combination of more selected from the group of a local area network, a wide area network, a public network, a private network, etc. The network nodes communicate over the transmission network.

According to one or more embodiments of the present disclosure, example 1 provides a data broadcasting method for a mesh network or a torus network based on an XY routing algorithm, where the mesh network or the torus network includes a plurality of transmission nodes arranged in array along at least two directions, the at least two directions include X and Y directions that intersect each other, and in the XY routing algorithm, a data packet is routed along the X direction until the data packet reaches a Y axis where a destination transmission node of the data packet is located and the data packet is routed along the Y direction until the data packet reaches the destination transmission node, the method includes: each of the transmission nodes, in response to receiving a broadcast data packet from a first neighboring transmission node in the X direction, transmitting the broadcast data packet to all neighboring transmission nodes except the first neighboring transmission node; and each of the transmission nodes, in response to receiving a broadcast data packet from a second neighboring transmission node in the Y direction, transmitting the broadcast data packet to neighboring transmission nodes, except the second neighboring transmission node, located in all other of the at least two directions except the X direction.

According to one or more embodiments of the present disclosure, example 2 provides the method of example 1, where the mesh network or the torus network is a two-dimensional network, and the plurality of transmission nodes are arranged along the X direction and the Y direction; where each of the transmission nodes, in response to receiving the broadcast data packet from the second neighboring transmission node in the Y direction, transmitting the broadcast data packet to neighboring transmission nodes, except the second neighboring transmission node, located in all other of the at least two directions except the X direction includes: each of the transmission nodes, in response to receiving the broadcast data packet from the second neighboring transmission node in the Y direction, transmitting the broadcast data packet to all neighboring transmission nodes, except the second neighboring transmission node, located only in the Y direction.

According to one or more embodiments of the present disclosure, example 3 provides the method of example 1, where the at least two directions further includes a Z direction, and the data broadcasting method further includes: each of the transmission nodes, in response to receiving a broadcast data packet from a third neighboring transmission node in the Z direction, transmitting the broadcast data packet to neighboring transmission nodes, except the third neighboring transmission node, located in all other of the at least two directions except the X direction and the Y direction.

According to one or more embodiments of the present disclosure, example 4 provides the method of example 3, the mesh network or the torus network is a three-dimensional network, and the plurality of transmission nodes are arranged along the X direction, the Y direction, and the Z direction;
where each of the transmission nodes, in response to receiving the broadcast data packet from the second neighboring transmission node in the Y direction, transmitting the broadcast data packet to neighboring transmission nodes, except the second neighboring transmission node, located in all other of the at least two directions except the X direction includes: each of the transmission nodes, in response to receiving the broadcast data packet from the second neighboring transmission node in the Y direction, transmitting the broadcast data packet to all neighboring transmission nodes, except the second neighboring transmission node, located only in the Y direction and the Z direction;
where each of the transmission nodes, in response to receiving the broadcast data packet from the third neighboring transmission node in the Z direction, transmitting the broadcast data packet to neighboring transmission nodes, except the third neighboring transmission node, located in all other of the at least two directions except the X direction and the Y direction includes: each of the transmission nodes, in response to receiving the broadcast data packet from the third neighboring transmission node in the Z direction, transmitting the broadcast data packet to all neighboring transmission nodes, except the third neighboring transmission node, located only in the Z direction.

According to one or more embodiments of the present disclosure, example 5 provides the method of example 1, where a plurality of transmission nodes located in a same line in the mesh network or the torus network are connected successively; the plurality of transmission nodes located in the same line include two end nodes and at least one intermediate node located between the two end nodes, in the mesh network, the two end nodes are indirectly connected through the at least one intermediate node, and in the torus network, the plurality of transmission nodes located in the same line are connected end to end in succession one by one, forming a closed loop.

According to one or more embodiments of the present disclosure, example 6 provides the method of example 1, where the plurality of transmission nodes include a second transmission node, and the method further includes: the second transmission node, in response to an error occurring when receiving a second broadcast data packet, sending a retransmission request to an initial transmission node of the second broadcast data packet in a point-to-point manner; and the initial transmission node of the second broadcast data packet, in response to receiving the retransmission request, transmitting the second broadcast data packet to the second transmission node in the point-to-point manner.

According to one or more embodiments of the present disclosure, example 7 provides the method of example 1, where the mesh network or the torus network is a network-on-chip of a chip; or, the mesh network or the torus network is used for data transmission between a plurality of network nodes.

According to one or more embodiments of the present disclosure, example 8 provides a transmission network, where the transmission network is a mesh network or a torus network, the transmission network includes a plurality of transmission nodes arranged in array along at least two directions, the at least two directions include X and Y directions that intersect each other, and data broadcasting of the transmission network is implemented based on an XY routing algorithm, in the XY routing algorithm, a data packet is routed along the X direction until the data packet reaches a Y axis where a destination transmission node of the data packet is located and the data packet is routed along the Y direction until the data packet reaches the destination transmission node; where each of the transmission nodes is configured to, in response to receiving a broadcast data packet from a first neighboring transmission node in the X direction, transmit the broadcast data packet to all neighboring transmission nodes except the first neighboring transmission node; and in response to receiving a broadcast data packet from a second neighboring transmission node in the Y direction, transmit the broadcast data packet to neighboring transmission nodes, except the second neighboring transmission node, located in all other of the at least two directions except the X direction.

According to one or more embodiments of the present disclosure, example 9 provides the transmission network of example 8, where the mesh network or the torus network is a two-dimensional network, and the plurality of transmission nodes are arranged along the X direction and the Y direction;
where each of the transmission nodes is further configured to, in response to receiving the broadcast data packet from the second neighboring transmission node in the Y direction, transmit the broadcast data packet to all neighboring transmission nodes, except the second neighboring transmission node, located only in the Y direction.

According to one or more embodiments of the present disclosure, example 10 provides the transmission network of example 8, where the at least two directions further includes a Z direction,
each of the transmission nodes is further configured to, in response to receiving a broadcast data packet from a third neighboring transmission node in the Z direction, transmit the broadcast data packet to neighboring transmission nodes, except the third neighboring transmission node, located in all other of the at least two directions except the X direction and the Y direction.

According to one or more embodiments of the present disclosure, example 11 provides the transmission network of example 10, where the mesh network or the torus network is a three-dimensional network, and the plurality of transmission nodes are arranged along the X direction, the Y direction, and the Z direction; where each of the transmission nodes is further configured to: in response to receiving the broadcast data packet from the second neighboring transmission node in the Y direction, transmit the broadcast data packet to all neighboring transmission nodes, except the second neighboring transmission node, located only in the Y direction and the Z direction; and in response to receiving the broadcast data packet from the third neighboring transmission node in the Z direction, transmit the broadcast data packet to all neighboring transmission nodes, except the third neighboring transmission node, located only in the Z direction.

According to one or more embodiments of the present disclosure, example 12 provides the transmission network of example 8, where a plurality of transmission nodes located in a same line in the transmission network are connected successively; the plurality of transmission nodes located in the same line include two end nodes and at least one intermediate node located between the two end nodes, when the transmission network is the mesh network, the two end nodes are indirectly connected through the at least one intermediate node, and when the transmission network is the torus network, the plurality of transmission nodes located in the same line are connected end to end in succession one by one to form a closed loop.

According to one or more embodiments of the present disclosure, example 13 provides the transmission network of example 8, where the plurality of transmission nodes include a second transmission node, the second transmission node is configured to, in response to an error occurring when receiving a second broadcast data packet, send a retransmission request to an initial transmission node of the second broadcast data packet in a point-to-point manner; and the initial transmission node of the second broadcast data packet is configured to, in response to receiving the retransmission request, transmit the second broadcast data packet to the second transmission node in the point-to-point manner.

According to one or more embodiments of the present disclosure, example 14 provides the transmission network of example 8, where the transmission network is a network-on-chip of a chip; or,
the transmission network is used for data transmission between a plurality of network nodes.

According to one or more embodiments of the present disclosure, example 15 provides an electronic device, including a transmission network implementing data broadcasting based on an XY routing algorithm, where the transmission network is a mesh network or a torus network, the transmission network includes a plurality of transmission nodes arranged in array along at least two directions, the at least two directions include X and Y directions that intersect each other, and in the XY routing algorithm, a data packet is routed along the X direction until the data packet reaches a Y axis where a destination transmission node of the data packet is located and the data packet is routed along the Y direction until the data packet reaches the destination transmission node; where each of the transmission nodes is configured to, in response to receiving a broadcast data packet from a first neighboring transmission node in the X direction, transmit the broadcast data packet to all neighboring transmission nodes except the first neighboring transmission node; and in response to receiving a broadcast data packet from a second neighboring transmission node in the Y direction, transmit the broadcast data packet to neighboring transmission nodes, except the second neighboring transmission node, located in all other of the at least two directions except the X direction.

The above description is only the explanation of a partial embodiment of the present disclosure and the used technical principle. It should be understood by those skilled in the art that the disclosure scope involved in the disclosure is not limited to the technical solution formed by the specific combination of the above technical features, but also covers other technical solutions formed by any combination of the above technical features or their equivalent features without departing from the above disclosed concept. For example, the technical solution formed by replacing the above features with (but not limited to) technical features with similar functions disclosed in the disclosure.

In addition, although the operations are depicted in a specific order, this should not be understood as requiring these operations to be performed in the specific order shown or in a sequential order. Under certain circumstances, multitasking and parallel processing may be beneficial. Similarly, although several specific implementation details are included in the above discussion, these should not be interpreted as limiting the scope of the present disclosure. Some features described in the context of separate embodiments may also be implemented in a single embodiment in combination. On the contrary, various features described in the context of a single embodiment may also be implemented in a plurality of embodiments alone or in any suitable sub-combination.

Although the subject matter has been described in language specific to structural features and/or logical actions of methods, it should be understood that the subject matter defined in the appended claims is not necessarily limited to the specific features or actions described above. On the contrary, the specific features and actions described above are only example forms of realizing the claims.

1. A data broadcasting method for a mesh network or a torus network based on an XY routing algorithm, wherein the mesh network or the torus network comprises a plurality of transmission nodes arranged in array along at least two directions, the at least two directions comprise X and Y directions that intersect each other, and in the XY routing algorithm, a data packet is routed along the X direction until the data packet reaches a Y axis where a destination transmission node of the data packet is located and the data packet is routed along the Y direction until the data packet reaches the destination transmission node, the method comprises:
each of the transmission nodes, in response to receiving a broadcast data packet from a first neighboring transmission node in the X direction, transmitting the broadcast data packet to all neighboring transmission nodes except the first neighboring transmission node; and
each of the transmission nodes, in response to receiving a broadcast data packet from a second neighboring transmission node in the Y direction, transmitting the broadcast data packet to neighboring transmission nodes, except the second neighboring transmission node, located in all other of the at least two directions except the X direction.

2. The data broadcasting method according to claim 1, wherein the mesh network or the torus network is a two-dimensional network, and the plurality of transmission nodes are arranged along the X direction and the Y direction;
wherein each of the transmission nodes, in response to receiving the broadcast data packet from the second neighboring transmission node in the Y direction, transmitting the broadcast data packet to neighboring transmission nodes, except the second neighboring transmission node, located in all other of the at least two directions except the X direction comprises:
each of the transmission nodes, in response to receiving the broadcast data packet from the second neighboring transmission node in the Y direction, transmitting the broadcast data packet to all neighboring transmission nodes, except the second neighboring transmission node, located only in the Y direction.

3. The data broadcasting method according to claim 1, wherein the at least two directions further comprises a Z direction,
and the data broadcasting method further comprises:
each of the transmission nodes, in response to receiving a broadcast data packet from a third neighboring transmission node in the Z direction, transmitting the broadcast data packet to neighboring transmission nodes, except the third neighboring transmission node, located in all other of the at least two directions except the X direction and the Y direction.

4. The data broadcasting method according to claim 3, wherein the mesh network or the torus network is a three-dimensional network, and the plurality of transmission nodes are arranged along the X direction, the Y direction, and the Z direction;
wherein each of the transmission nodes, in response to receiving the broadcast data packet from the second neighboring transmission node in the Y direction, transmitting the broadcast data packet to neighboring transmission nodes, except the second neighboring transmission node, located in all other of the at least two directions except the X direction comprises:
each of the transmission nodes, in response to receiving the broadcast data packet from the second neighboring transmission node in the Y direction, transmitting the broadcast data packet to all neighboring transmission nodes, except the second neighboring transmission node, located only in the Y direction and the Z direction;
wherein each of the transmission nodes, in response to receiving the broadcast data packet from the third neighboring transmission node in the Z direction, transmitting the broadcast data packet to neighboring transmission nodes, except the third neighboring transmission node, located in all other of the at least two directions except the X direction and the Y direction comprises:
each of the transmission nodes, in response to receiving the broadcast data packet from the third neighboring transmission node in the Z direction, transmitting the broadcast data packet to all neighboring transmission nodes, except the third neighboring transmission node, located only in the Z direction.

5. The data broadcasting method according to claim 1, wherein
a plurality of transmission nodes located in a same line in the mesh network or the torus network are connected successively;
the plurality of transmission nodes located in the same line comprise two end nodes and at least one intermediate node located between the two end nodes, in the mesh network, the two end nodes are indirectly connected through the at least one intermediate node, and in the torus network, the plurality of transmission nodes located in the same line are connected end to end in succession one by one, forming a closed loop.

6. The data broadcasting method according to claim 1, wherein the plurality of transmission nodes comprise a second transmission node, and the method further comprises:
the second transmission node, in response to an error occurring when receiving a second broadcast data packet, sending a retransmission request to an initial transmission node of the second broadcast data packet in a point-to-point manner; and
the initial transmission node of the second broadcast data packet, in response to receiving the retransmission request, transmitting the second broadcast data packet to the second transmission node in the point-to-point manner.

7. The data broadcasting method according to claim 1, wherein
the mesh network or the torus network is a network-on-chip of a chip; or,
the mesh network or the torus network is used for data transmission between a plurality of network nodes.

8. A transmission network, wherein the transmission network is a mesh network or a torus network, the transmission network comprises a plurality of transmission nodes arranged in array along at least two directions, the at least two directions comprise X and Y directions that intersect each other, and data broadcasting of the transmission network is implemented based on an XY routing algorithm, in the XY routing algorithm, a data packet is routed along the X direction until the data packet reaches a Y axis where a destination transmission node of the data packet is located and the data packet is routed along the Y direction until the data packet reaches the destination transmission node;
wherein each of the transmission nodes is configured to, in response to receiving a broadcast data packet from a first neighboring transmission node in the X direction, transmit the broadcast data packet to all neighboring transmission nodes except the first neighboring transmission node; and in response to receiving a broadcast data packet from a second neighboring transmission node in the Y direction, transmit the broadcast data packet to neighboring transmission nodes, except the second neighboring transmission node, located in all other of the at least two directions except the X direction.

9. The transmission network according to claim 8, wherein the mesh network or the torus network is a two-dimensional network, and the plurality of transmission nodes are arranged along the X direction and the Y direction;
wherein each of the transmission nodes is further configured to, in response to receiving the broadcast data packet from the second neighboring transmission node in the Y direction, transmit the broadcast data packet to all neighboring transmission nodes, except the second neighboring transmission node, located only in the Y direction.

10. The transmission network according to claim 8, wherein the at least two directions further comprises a Z direction,
each of the transmission nodes is further configured to, in response to receiving a broadcast data packet from a third neighboring transmission node in the Z direction, transmit the broadcast data packet to neighboring transmission nodes, except the third neighboring transmission node, located in all other of the at least two directions except the X direction and the Y direction.

11. The transmission network according to claim 10, wherein the mesh network or the torus network is a three-dimensional network, and the plurality of transmission nodes are arranged along the X direction, the Y direction, and the Z direction;
wherein each of the transmission nodes is further configured to:
in response to receiving the broadcast data packet from the second neighboring transmission node in the Y direction, transmit the broadcast data packet to all neighboring transmission nodes, except the second neighboring transmission node, located only in the Y direction and the Z direction; and
in response to receiving the broadcast data packet from the third neighboring transmission node in the Z direction, transmit the broadcast data packet to all neighboring transmission nodes, except the third neighboring transmission node, located only in the Z direction.

12. The transmission network according to claim 8, wherein
a plurality of transmission nodes located in a same line in the transmission network are connected successively;
the plurality of transmission nodes located in the same line comprise two end nodes and at least one intermediate node located between the two end nodes, when the transmission network is the mesh network, the two end nodes are indirectly connected through the at least one intermediate node, and when the transmission network is the torus network, the plurality of transmission nodes located in the same line are connected end to end in succession one by one to form a closed loop.

13. The transmission network according to claim 8, wherein the plurality of transmission nodes comprise a second transmission node, the second transmission node is configured to, in response to an error occurring when receiving a second broadcast data packet, send a retransmission request to an initial transmission node of the second broadcast data packet in a point-to-point manner; and
the initial transmission node of the second broadcast data packet is configured to, in response to receiving the retransmission request, transmit the second broadcast data packet to the second transmission node in the point-to-point manner.

14. The transmission network according to claim 8, wherein
the transmission network is a network-on-chip of a chip; or,
the transmission network is used for data transmission between a plurality of network nodes.

15. An electronic device, comprising a transmission network implementing data broadcasting based on an XY routing algorithm, wherein the transmission network is a mesh network or a torus network, the transmission network comprises a plurality of transmission nodes arranged in array along at least two directions, the at least two directions comprise X and Y directions that intersect each other, and in the XY routing algorithm, a data packet is routed along the X direction until the data packet reaches a Y axis where a destination transmission node of the data packet is located and the data packet is routed along the Y direction until the data packet reaches the destination transmission node;
wherein each of the transmission nodes is configured to, in response to receiving a broadcast data packet from a first neighboring transmission node in the X direction, transmit the broadcast data packet to all neighboring transmission nodes except the first neighboring transmission node; and in response to receiving a broadcast data packet from a second neighboring transmission node in the Y direction, transmit the broadcast data packet to neighboring transmission nodes, except the second neighboring transmission node, located in all other of the at least two directions except the X direction.

16. The electronic device according to claim 15, wherein the mesh network or the torus network is a two-dimensional network, and the plurality of transmission nodes are arranged along the X direction and the Y direction;
wherein each of the transmission nodes is further configured to, in response to receiving the broadcast data packet from the second neighboring transmission node in the Y direction, transmit the broadcast data packet to all neighboring transmission nodes, except the second neighboring transmission node, located only in the Y direction.

17. The electronic device according to claim 15, wherein the at least two directions further comprises a Z direction,
each of the transmission nodes is further configured to, in response to receiving a broadcast data packet from a third neighboring transmission node in the Z direction, transmit the broadcast data packet to neighboring transmission nodes, except the third neighboring transmission node, located in all other of the at least two directions except the X direction and the Y direction.

18. The electronic device according to claim 17, wherein the mesh network or the torus network is a three-dimensional network, and the plurality of transmission nodes are arranged along the X direction, the Y direction, and the Z direction;
wherein each of the transmission nodes is further configured to:
in response to receiving the broadcast data packet from the second neighboring transmission node in the Y direction, transmit the broadcast data packet to all neighboring transmission nodes, except the second neighboring transmission node, located only in the Y direction and the Z direction; and
in response to receiving the broadcast data packet from the third neighboring transmission node in the Z direction, transmit the broadcast data packet to all neighboring transmission nodes, except the third neighboring transmission node, located only in the Z direction.

19. The electronic device according to claim 15, wherein
a plurality of transmission nodes located in a same line in the transmission network are connected successively;
the plurality of transmission nodes located in the same line comprise two end nodes and at least one intermediate node located between the two end nodes, when the transmission network is the mesh network, the two end nodes are indirectly connected through the at least one intermediate node, and when the transmission network is the torus network, the plurality of transmission nodes located in the same line are connected end to end in succession one by one to form a closed loop.

20. The electronic device according to claim 15, wherein the plurality of transmission nodes comprise a second transmission node, the second transmission node is configured to, in response to an error occurring when receiving a second broadcast data packet, send a retransmission request to an initial transmission node of the second broadcast data packet in a point-to-point manner; and
the initial transmission node of the second broadcast data packet is configured to, in response to receiving the retransmission request, transmit the second broadcast data packet to the second transmission node in the point-to-point manner.
